(19) United States
(12) Patent Application Publication
(10) Pub. No.: US 2023/0405559 A1
(43) Pub. Date: Dec. 21, 2023

(54) TEMPLATED ENCAPSULATION OF PT-BASED CATALYSTS FOR PROMOTING HIGH-TEMPERATURE STABILITY

(71) Applicant: The Board of Trustees of the Leland Stanford Junior University, Stanford, CA (US)

(72) Inventors: Matteo CARGNELLO, Stanford, CA (US); Aisulu AITBEKOVA, Stanford, CA (US)

(73) Assignee: The Board of Trustees of the Leland Stanford Junior University, Stanford, CA (US)

(21) Appl. No.: 18/335,772

(22) Filed: Jun. 15, 2023

Related U.S. Application Data
(60) Provisional application No. 63/352,987, filed on Jun. 16, 2022.

(51) Int. Cl. B01J 23/42; B01J 23/44; B01J 21/04; B01J 35/00; B01J 37/00; B01J 37/02; B01J 37/08; B01D 53/86

(52) U.S. Cl. CPC B01J 23/42; B01J 23/44; B01J 21/04; B01J 35/0013; B01J 35/006; B01J 37/0018; B01J 37/0211; B01J 37/0205; B01J 37/086; B01J 37/0213; B01J 37/0236; B01J 37/024; B01D 53/86; B01D 2255/1021; B01D 2255/1023

(57) ABSTRACT

One or more embodiments relate to stable catalysts prepared through the encapsulation of platinum particles inside an alumina framework. These catalysts do not sinter at 800° C. in the presence of oxygen and steam, conditions in which conventional catalysts sinter to large extents, while showing similar reaction rates. Extending this approach to Pd/Pt bimetallic catalysts leads to maintained small particle size at temperatures as high as 1,100° C. in air and steam. This strategy can be broadly applied to other metal and metal oxides for applications where sintering is a major cause of materials deactivation.

### CROSS-REFERENCE TO RELATED APPLICATIONS

The present application claims priority to U.S. Provisional Patent Application No. 63/352,987 filed Jun. 16, 2022, the contents of which are incorporated herein by reference in their entirety.

### STATEMENT OF GOVERNMENT SPONSORED RESEARCH

This invention was made with Government support under contract DE-AC02-76SF00515 awarded by the Department of Energy. The Government has certain rights in the invention.

### TECHNICAL FIELD

The present embodiments relate generally to catalysts, and more particularly to methods and apparatuses for a stable and active platinum-alumina catalyst that maintains high activity under harsh conditions.

### BACKGROUND

Stable catalysts are essential to address energy and environmental challenges, especially in harsh environment applications (e.g. high temperature, oxidizing atmosphere, steam, etc.). In such conditions, supported metal catalysts deactivate due to sintering—a process where initially small nanoparticles grow into larger ones with reduced active surface area. Strategies to stabilize them lead to decreased performance.

It is against this backdrop that the present Applicants sought to advance the state of the art.

### SUMMARY

One or more embodiments relate to stable catalysts prepared through the encapsulation of platinum particles inside an alumina framework. These catalysts do not sinter at 800° C. in the presence of oxygen and steam, conditions in which conventional catalysts sinter to large extents, while showing similar reaction rates. Extending this approach to Pd/Pt bimetallic catalysts leads to maintained small particle size at temperatures as high as 1,100° C. in air and steam. This strategy can be broadly applied to other metal and metal oxides for applications where sintering is a major cause of materials deactivation.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1(a) to 1(k) illustrate example aspects of the synthesis of Pt@Al₂O₃ in accordance with embodiments.

FIGS. 2(a) to 2(i) illustrate example aspects of prepared Pt@Al₂O₃ in accordance with embodiments.

FIGS. 3(a) and 3(b) illustrate example properties of Pt@Al₂O₃ according to embodiments.

FIGS. 4(a) to 4(f) illustrate example aspects of as-synthesized PdPt@Al₂O₃ according to embodiments.

FIGS. 5(a) to 5(e) illustrate example characterization of Pt@Al₂O₃ according to embodiments.

FIGS. 6(a) to 6(e) illustrate further example characterization of Pt/Al₂O₃ according to embodiments.

FIGS. 7(a) and 7(b) illustrate further example characterization of Pt/Al₂O₃ according to embodiments.

FIGS. 8(a) to 8(e) illustrates further example characterization of Pt/Al₂O₃ according to embodiments.

FIGS. 9(a) to 9(d) illustrate example EXAFS and XPS characterization of as-prepared and aged Pt@Al₂O₃ and Pt/Al₂O₃ according to embodiments.

FIGS. 10(a) and 10(b) illustrate further example characterization of Pt/Al₂O₃ according to embodiments.

FIG. 11 is an example TEM image showing large Pt NPs in a Pt@Al₂O₃ sample according to embodiments after 50 h aging.

FIG. 12 is an example EDS spectrum of as-synthesized PdPt@Al₂O₃ according to embodiments.

FIGS. 13(a) to 13(c) illustrate further example aspects of PdPt/Al₂O₃ according to embodiments.

FIGS. 14(a) to 14(g) illustrate further example aspects of PdPt/Al₂O₃ according to embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

### INTRODUCTION

The design of active and stable catalysts is important to address energy challenges while reducing environmental impacts. Platinum-group elements (PGE) are widely used in industrial chemical conversions. Supported PGEs consisting of metal nanoparticles (NPs) dispersed on metal oxides, such as platinum on alumina, are used in automotive emission control and other applications. (Kunwar, D. et al. Investigating anomalous growth of platinum particles during accelerated aging of diesel oxidation catalysts. Appl. Catal. B 266, 118598 (2020); Yang, A.-C. et al. Revealing the structure of a catalytic combustion active-site ensemble combining uniform nanocrystal catalysts and theory insights. Proc. Natl. Acad. Sci. 117, 14721-14729 (2020).) Under harsh operating conditions (e.g., high temperature, oxidizing environment, steam) these catalysts deactivate and become less efficient in facilitating the desired chemical transformations. The major deactivation pathway occurs due to sintering—a process where the initially small NPs grow into larger ones with reduced active surface area. (Ogel, E. et al. Impact of Preparation Method and Hydrothermal Aging on Particle Size Distribution of Pt/γ-Al₂O₃ and Its Performance in CO and NO Oxidation. J. Phys. Chem. C 123, 5433-5446 (2019); Leistner, K., Gonzalez Braga, C., Kumar, A., Kamasamudram, K. & Olsson, L. Volatilisation and subsequent deposition of platinum oxides from diesel oxidation catalysts. Appl. Catal. B 241, 338-350 (2019).) Preventing these scarce, expensive, and environmentally detrimentally to mine PGEs from sintering has been a long-standing challenge in the catalysis research community.

Researchers have proposed several anti-sintering strategies: encapsulation of metal particles inside mesoporous silica (Joo, S. H. et al. Thermally stable Pt/mesoporous silica core-shell nanocatalysts for high-temperature reactions. Nat. Mater. 8, 126-131 (2009); Lee, I., Zhang, Q., Ge, J., Yin, Y. & Zaera, F. Encapsulation of supported Pt nanoparticles with mesoporous silica for increased catalyst stability. Nano Res. 4, 115-123 (2011)) and zeolites, (Moliner, M. et al. Reversible Transformation of Pt Nanoparticles into Single Atoms inside High-Silica Chabazite Zeolite. J. Am. Chem. Soc. 138, 15743-15750 (2016); Zhang, J. et al. Sinter-resistant metal nanoparticle catalysts achieved by immobilization within zeolite crystals via seed-directed growth. Nat. Catal. 1, 540-546 (2018)) core-shell NPs, (Cheng, N. et al. Extremely Stable Platinum Nanoparticles Encapsulated in a Zirconia Nanocage by Area-Selective Atomic Layer Deposition for the Oxygen Reduction Reaction. Adv. Mater. 27, 277-281 (2015)) compartmentalization, (Liu, J., Ji, Q., Imai, T., Ariga, K. & Abe, H. Sintering-Resistant Nanoparticles in Wide-Mouthed Compartments for Sustained Catalytic Performance. Sci. Rep. 7, 41773 (2017); Yang, X. et al. Taming the stability of Pd active phases through a compartmentalizing strategy toward nanostructured catalyst supports. Nat. Commun. 10, 1611 (2019)) and strengthening of metal-support interactions. (Jeong, H. et al. Highly durable metal ensemble catalysts with full dispersion for automotive applications beyond single-atom catalysts. Nat. Catal. 3, 368-375 (2020); Li, W.-Z. et al. Stable platinum nanoparticles on specific MgAl₂O₄ spinel facets at high temperatures in oxidizing atmospheres. Nat. Commun. 4, 2481 (2013); Jones, J. et al. Thermally stable single-atom platinum-on-ceria catalysts via atom trapping. Science 353, 150-154 (2016).) Most of these approaches, however, lead to activity-stability trade-offs, where higher stability is achieved at the expense of activity. Furthermore, platinum/alumina catalysts are particularly challenging to stabilize because of the formation of volatile, and thus mobile, PtO₂ species. (Datye, A. K. & Votsmeier, M. Opportunities and challenges in the development of advanced materials for emission control catalysts. Nat. Mater. 20, 1049-1059 (2020); Wynblatt, P. & Gjostein, N. A. Particle growth in model supported metal catalysts-I. Theory. Acta Metall. 24, 1165-1174 (1976); Plessow, P. N. & Abild-Pedersen, F. Sintering of Pt Nanoparticles via Volatile PtO2: Simulation and Comparison with Experiments. ACS Catal. 6, 7098−7108 (2016)).

According to certain aspects, the present embodiments relate to encapsulated platinum/alumina catalysts (Pt@Al₂O₃) that are as active as conventional supported systems while being stable at high temperatures under hydrothermal conditions (oxygen, steam). These encapsulated Pt NPs show unprecedented stability for a hydrocarbon combustion reaction, where the NPs maintain their initial size (˜3.8 nm) and catalytic activity after aging at 800° C. By contrast, the Pt in a typical supported Pt/Al₂O₃ sample sinters into very large particles (>100 nm). Demonstrate herein is the versatility of this approach by encapsulating palladium/platinum (Pd/Pt) bimetallic NPs in alumina. The addition of Pd to the catalyst formulation improves the stability of the system. (Goodman, E. D. et al. Uniform Pt/Pd Bimetallic Nanocrystals Demonstrate Platinum Effect on Palladium Methane Combustion Activity and Stability. ACS Catal. 7, 4372-4380 (2017)). The Pd/Pt@Al₂O₃ catalyst shows exceptional stability for supported noble metal catalysts by maintaining its activity and stability after aging at 1,100° C. in air and steam.

Main Text

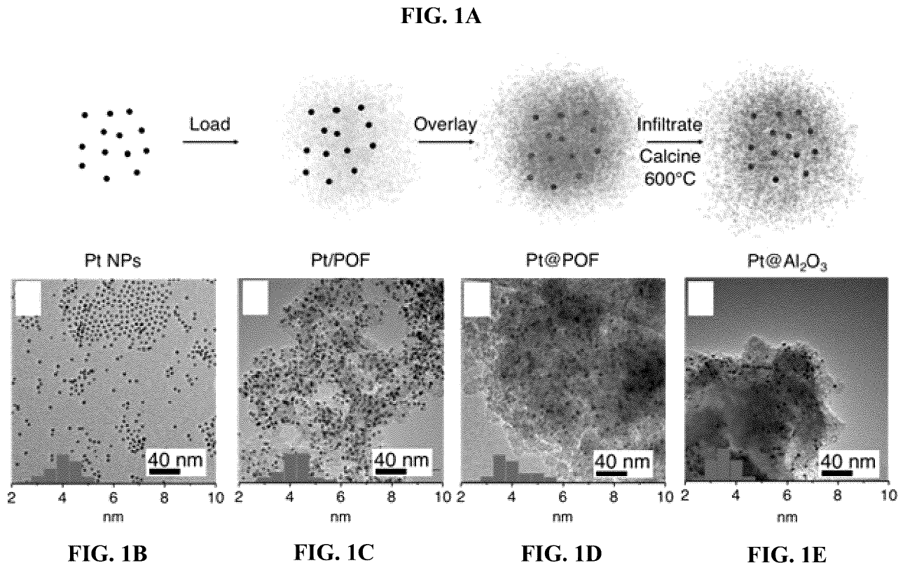

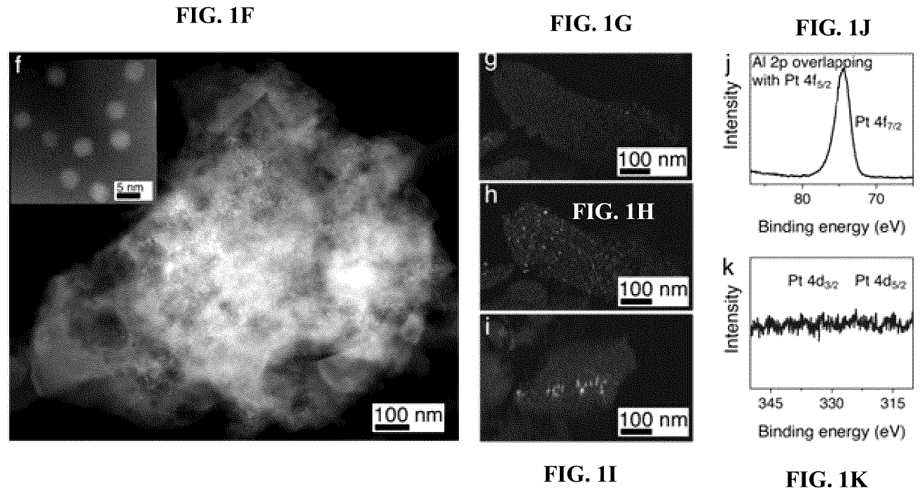

FIGS. 1(a) to 1(k) illustrate example aspects of the synthesis of Pt@Al₂O₃ in accordance with embodiments. FIG. 1(a) is a schematic diagram of the synthesis of Pt@Al₂O₃ according to embodiments. FIGS. 1(b) to 1(e) are representative TEM images with corresponding NP size distributions of: (b) starting Pt NPs; (c) Pt NPs deposited on POF (Pt/POF); (d) Pt NPs encapsulated in POF (Pt@POF); (e) Pt NPs encapsulated in Al₂O₃ after calcination at 600° C. (Pt@Al₂O₃). FIG. 1(f) is a Representative HAADF-STEM image of Pt@Al₂O₃ (inset is a magnification showing Pt NPs encapsulated within the alumina matrix). FIGS. 1(g) to 1(i) illustrate a 3D reconstruction using HAADF-STEM tomography of a representative Pt@Al₂O₃ grain according to embodiments: (g) is a XY slice (top view); (h) is a XY slice (depth profiling); and (i) is a YZ slice; Z is the beam direction; slices are colored using the ‘magma’ colormap. FIGS. 1(j) and 1(k) illustrate XPS characterization of the Al 2p (FIG. 1(j)) and Pt 4d (FIG. 1(k)) signals in the Pt@Al₂O₃ sample.

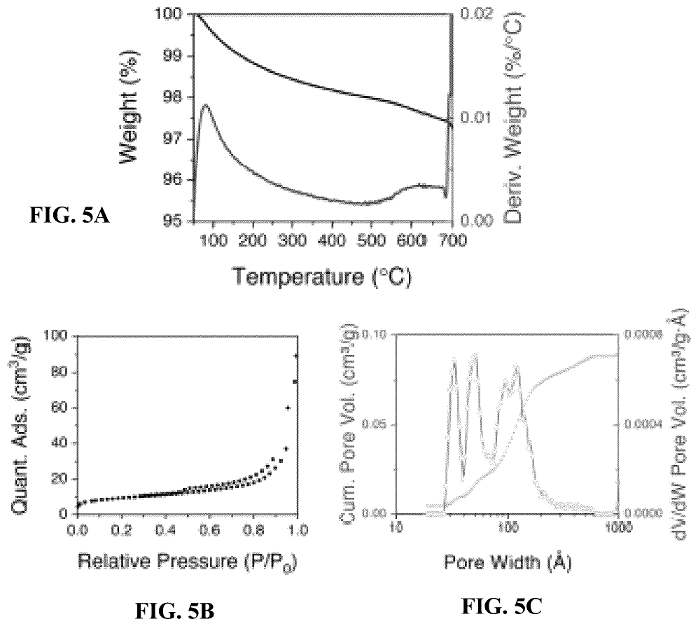

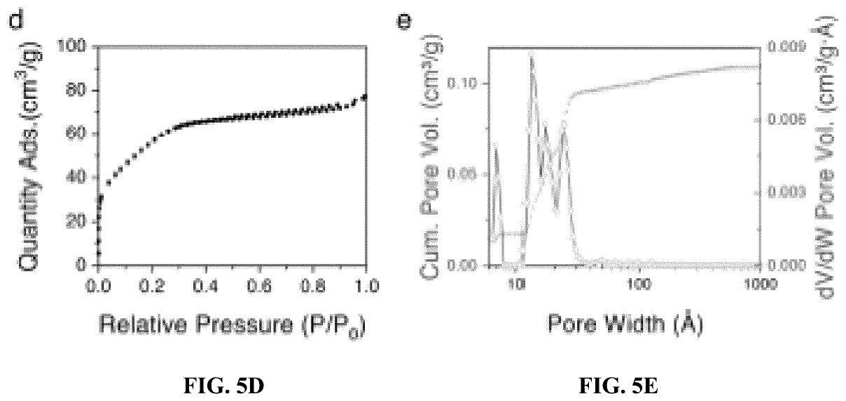

For example, preparation of the encapsulated catalyst followed a templating approach (FIG. 1(a)) and started by depositing colloidally-synthesized Pt NPs with a size of 3.8±0.6 nm (FIG. 1(b)) onto a separately prepared porous polymer (polymer organic framework, POF) through wet impregnation. This procedure resulted in uniformly distributed Pt NPs on the POF surface (FIG. 1(c)). Then, the Pt NPs were encapsulated inside additional POF layers by introducing the Pt/POF sample into a new polymer growth solution to obtain Pt@POF. Previous works demonstrated that this process results in NPs that are encapsulated inside the porous, intact POF layers. (Riscoe, A. R. et al. Transition state and product diffusion control by polymer-nanocrystal hybrid catalysts. Nat. Catal. 2, 852-863 (2019)). The NP size remained the same throughout the synthesis procedure, as evidenced by the particle size distribution histograms obtained from transmission electron microscopy (TEM) images (FIGS. 1(b) to 1(d)). Finally, the Pt@POF sample was converted into Pt@Al₂O₃ by infiltrating the pores of the polymer with an alumina precursor and subsequently removing the polymer by calcination, (Lu, A.-H. & Schuth, F. Nanocasting: A Versatile Strategy for Creating Nanostructured Porous Materials. Adv. Mater. 18, 1793-1805 (2006)) producing the Pt@Al₂O₃ catalyst. This calcination step at 600° C. did not result in any measurable sintering of the Pt NPs (FIG. 1(e)). High-angle annular dark-field scanning transmission electron microscopy (HAADF-STEM) showed the uniform dispersion of small Pt NPs throughout the porous alumina grains (FIG. 1(f)) and inset). The Pt weight loading was 0.5 wt. % as determined by X-ray fluorescence (XRF) measurements (Table 1). Thermal gravimetric analysis of the material showed less than 3 wt. % loss in the sample mass upon heating in air to 700° C., likely due to the presence of adsorbates from air storage (FIG. 5(a)) and not to residual organics. Nitrogen physisorption showed that the alumina was mesoporous with a Brunauer-Emmett-Teller (BET) surface area of 42 m² g⁻¹ (FIGS. 5(b) and 5(c)).

The NPs were not observed on the surface of the alumina in HAADF-STEM 3D tomography reconstructed volumes (FIG. 1(g)) and were only visible upon depth profiling through the alumina grains (FIG. 1(h)). The orthogonal projection of the reconstructed volume confirmed that the NPs were inside the alumina (FIG. 1(i)).

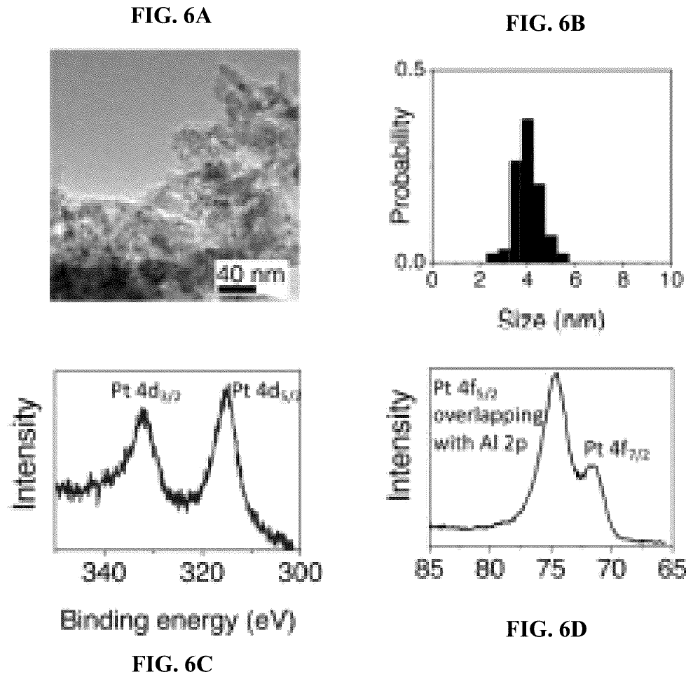

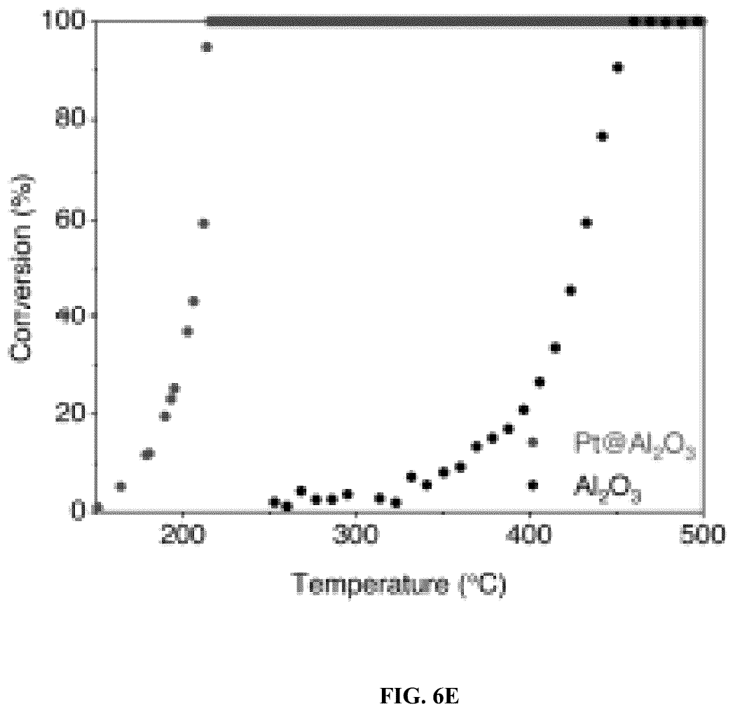

The absence of X-ray photoelectron spectroscopy (XPS) Pt 4f_{5/2}, Pt 4f_{7/2}, Pt 4d_{3/2}, and Pt4d_{5/2} signals (FIGS. 1(j) and 1(k)) demonstrated the successful NP encapsulation under an Al₂O₃ layer of at least 1-2 nm given the surface sensitivity of XPS (see below). XPS and tomography results indicate that the NPs were encapsulated in the aluminum oxide. For comparison, prepared were several control samples, namely Pt/Al₂O₃, Pt/γ-Al₂O₃, and Pt-free Al₂O₃. The Pt/Al₂O₃ sample was made from the same Pt NPs and alumina as for Pt@Al₂O₃ except that the NPs were deposited on the alumina surface instead of being incorporated throughout the alumina support, thus simulating a conventional supported catalyst (FIGS. 6(a) and 6(b), Table 1). The Pt/γ-Al₂O₃ sample was prepared by depositing the same Pt NPs on a commercial γ-Al₂O₃ support. Unlike the encapsulated sample, Pt/Al₂O₃ showed intense Pt 4d_{5/2, 4}d_{3/2} XPS signals (FIG. 6(c)) as well as Pt 4f_{7/2} and 4f_{5/2} overlapping with Al 2p signal (FIG. 6(d)), demonstrating that the particles were located on the alumina surface rather than underneath it. These Pt@Al₂O₃ and Pt/Al₂O₃ samples, therefore, represent catalysts with the same Pt NPs and textural support properties, the only difference being the position of the Pt NPs with respect to the alumina support.

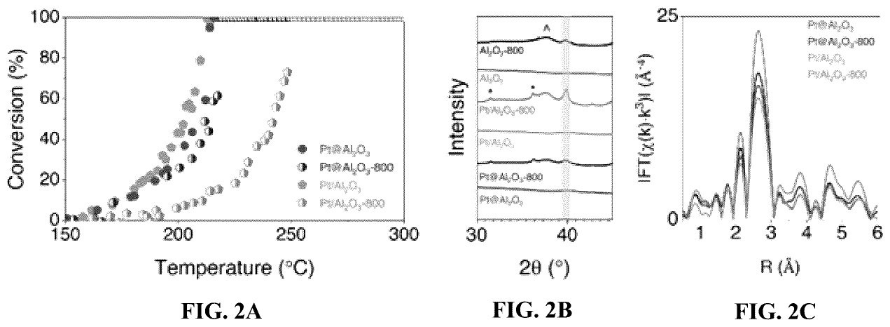

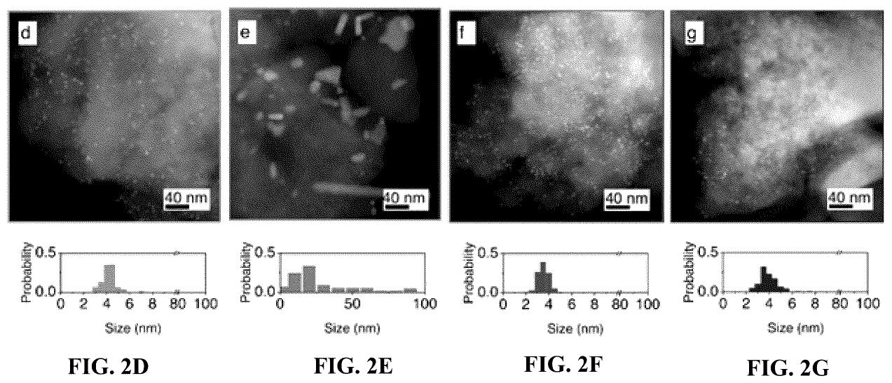

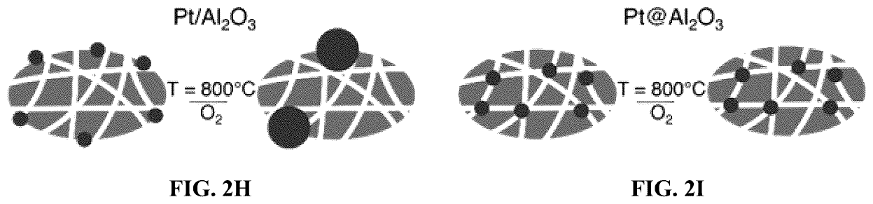

FIGS. 2(a) to 2(l) illustrate example aspects of prepared Pt@Al₂O₃ in accordance with embodiments. FIG. 2(a) illustrates propene combustion activity for as-prepared Pt@Al₂O₃ and Pt/Al₂O₃, and after aging at 800° C. for 2 h in the reaction mixture (Pt@Al₂O₃-800 and Pt/Al₂O₃-800). Reaction mixture: 0.15 vol. % C3H6, 3 vol. % O₂, and 5 vol. % steam, balance Ar (40 ml/min total flow). FIG. 2(b) illustrates XRD patterns for the samples and the bare support. \hat{ } and * represent diffractions peaks due to γ-Al₂O₃ and quartz diluent, respectively. Highlighted region at 400 indicates overlapping γ-Al₂O₃ and Pt(111) diffraction peaks. FIG. 2(c) illustrates Magnitude of the k3-weighted Fourier-transformed (FT) EXAFS data. The range in k (the wavenumber) was 3.6-14.3 Å⁻¹ and the range in R (the interatomic distance) was 1.9-4.9 A. FIGS. 2(d) to 2(g) are representative HAADF-STEM images and corresponding particle size distributions (bottom) of fresh and aged Pt/Al₂O₃ ((d-e)) and Pt@Al₂O₃ ((f-g)). FIG. 2(h) is an example schematic summarizing the sintering process occurring in the Pt/Al₂O₃ sample after aging and FIG. 2(i) is an example schematic of the stability of the Pt@Al₂O₃ sample.

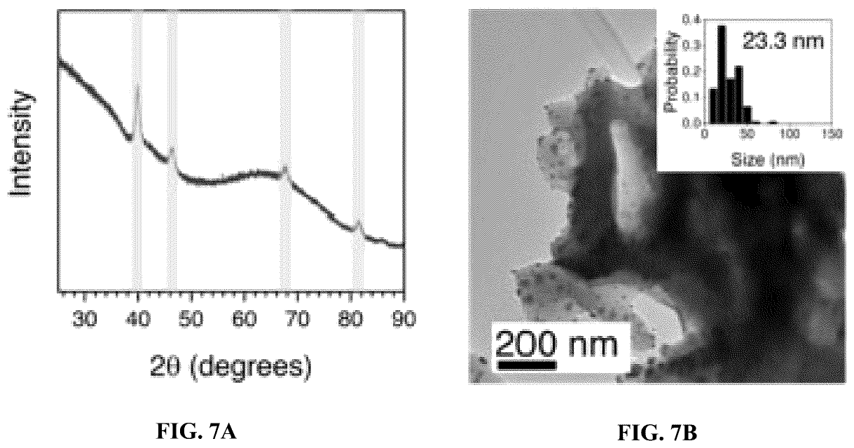

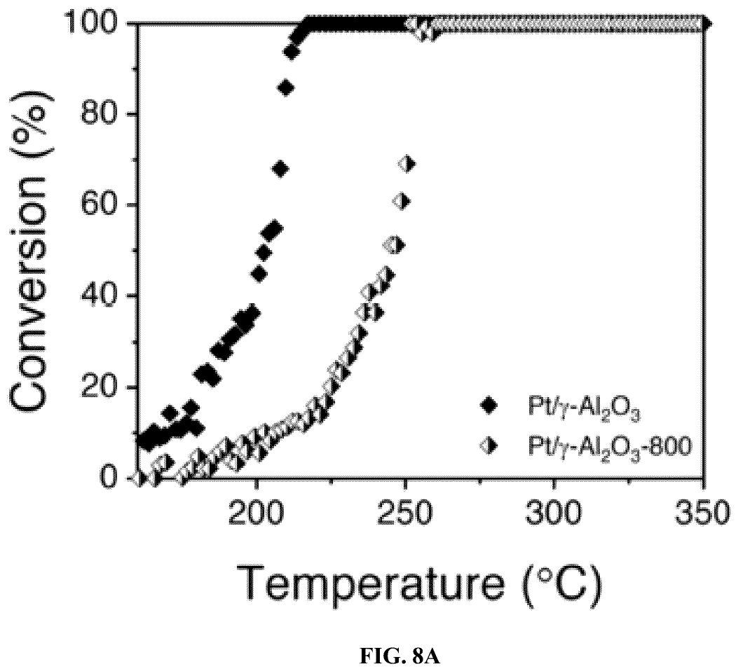

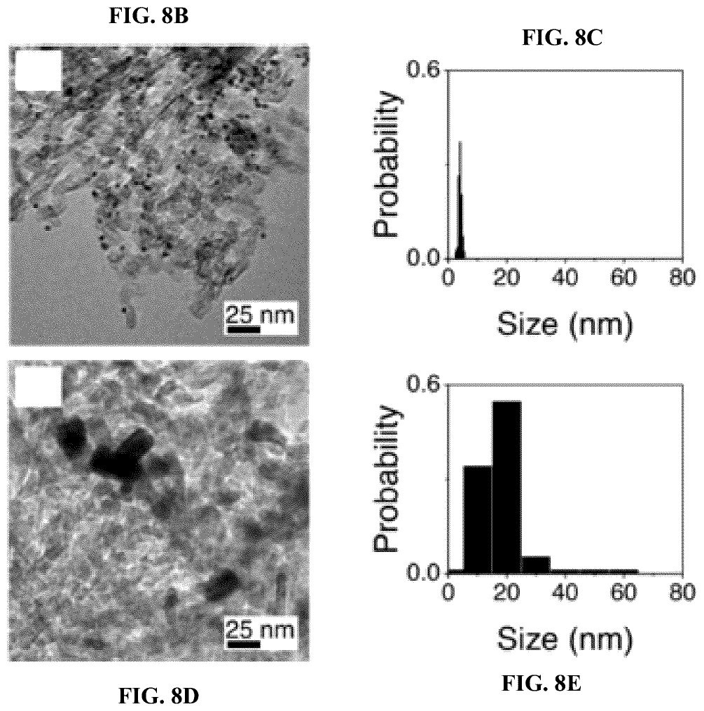

Catalytic activity and stability measurements were performed using propene complete oxidation as a model reaction for the combustion of residual hydrocarbons in emission control systems. Hydrocarbons, including propene, are among the most abundant exhaust gases emitted into the atmosphere. In both of the as-prepared Pt@Al₂O₃ and Pt/Al₂O₃ catalysts, complete propene conversion was reached at −215° C. in a reaction flow containing a low concentration of propene (0.15 vol. %), oxygen, and 5 vol. % steam to simulate exhaust conditions (FIG. 2(a)). After aging at 800° C. for 2 h in the reaction mixture to simulate high-temperature conditions in the exhaust, the two samples showed very different performance. The activity of the 800° C.-aged Pt@Al₂O₃ (labeled Pt@Al₂O₃-800) was similar to that of the as-prepared catalyst, as evidenced by the <3° C. difference in the temperatures to reach complete propene conversion. By contrast, the aged Pt/Al₂O₃-800 sample showed activity loss demonstrated by the shift in the light-off curve by 35° C. towards higher temperatures. The Pt-free alumina support was much less active and reached complete propene conversion only at temperatures above 450° C. (FIGS. 7(a) and 7(b)), thus demonstrating that the excellent activity of the Pt@Al₂O₃ sample was due to the Pt phase. Also performed were replicate runs of the light off curves of the encapsulated Pt@Al₂O₃ catalyst (FIGS. 8(a) to 8(e)). The results show that the reactivity data persist during multiple runs.

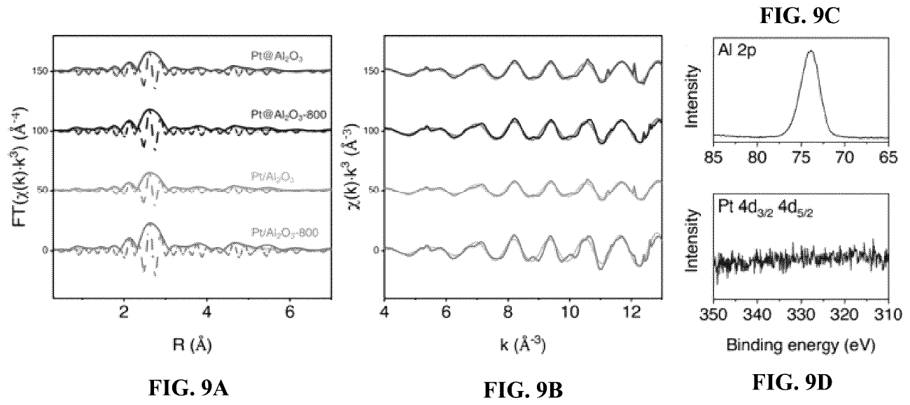

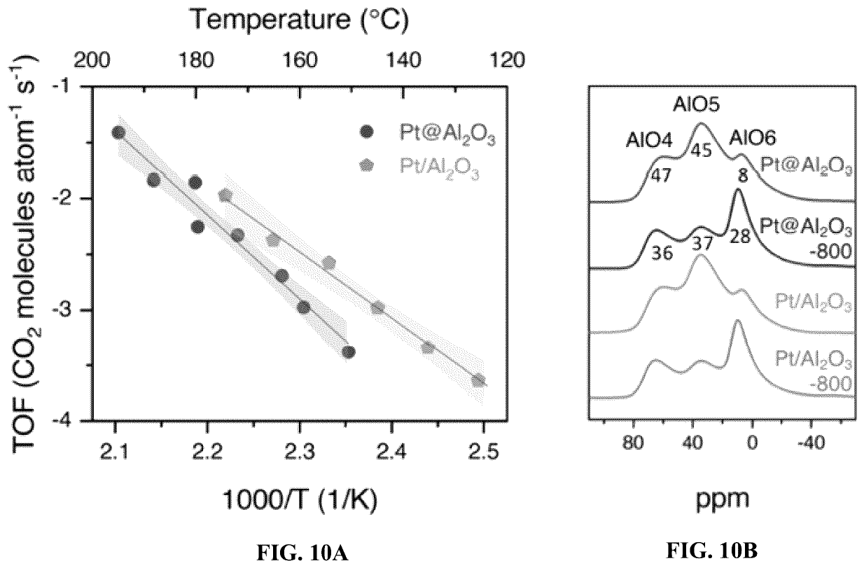

It was hypothesized that the loss of activity in Pt/Al₂O₃ upon aging was due to Pt sintering, which is a well-established phenomenon in Pt catalysts under oxidizing conditions. (Wynblatt, P. Particle growth in model supported metal catalysts-II. Comparison of experiment with theory. Acta Metall. 24, 1175-1182 (1976)). HAADF-STEM characterization of as-prepared and aged Pt/Al₂O₃ catalysts showed an increase in the average Pt NP size from 3.8 nm to 17.2 nm (FIGS. 2(d) and 2(e)), with faceted particles larger than 100 nm that were clearly visible on the support. This is equivalent to a loss of 78% of Pt surface area, which explains the significant drop in Pt catalytic activity. The Pt/Al₂O₃ catalyst sintered even after the calcination treatment at 600° C. (the temperature that was used to prepare the Pt@Al₂O₃ sample), with the resulting XRD diffractogram showing intense peaks from Pt, and TEM images showing an increase in average particle size from 3.8 to 23.2 nm (FIGS. 9(a) to 9(d)). Unlike Pt/Al₂O₃, the Pt@Al₂O₃ sample showed small particles still present throughout the catalyst after the 800° C. aging, with only minor changes in the overall particle size distribution (FIGS. 2(f) and 2(g)). The additional control Pt/γ-Al₂O₃ catalyst, made by depositing the same Pt NPs on a commercial 7-Al₂O₃ support at the same metal loading as the Pt@Al₂O₃ sample, was as active as the Pt/Al₂O₃ and Pt@Al₂O₃ samples (FIG. 10(a)). However, after the 800° C. aging, Pt/γ-Al₂O₃ exhibited the same drastic decrease in activity as the Pt/Al₂O₃ again due to the sintering of the Pt NPs from 3.8 nm to 13.7 nm (FIGS. 10(a) and 10(b)), thus confirming that the underlying support chemistry or crystallinity did not play any major role in stabilizing the Pt NPs.

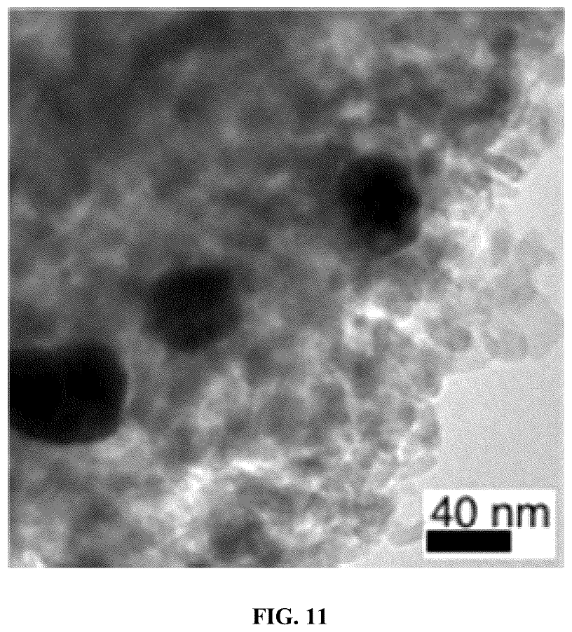

X-ray diffraction analysis showed the absence of strong diffraction peaks in the as-prepared catalysts, suggesting that the alumina was amorphous (FIGS. 2(b) and 11). The aging treatment led to the alumina crystallization, as indicated by the appearance of diffraction peaks attributable to the γ-Al₂O₃ phase. Although it was not possible to determine Pt particle size by XRD due to the overlapping γ-Al₂O₃ and Pt(111) diffraction peaks at 40°, no increase in the intensity for this peak was found in the Pt@Al₂O₃-800 sample (FIGS. 2(b) and 11). By contrast, the intensity of the diffraction peak at 40° in the Pt/Al₂O₃-800 sample increased relative to the diffraction peak at 670 that is purely due to alumina. This result further demonstrates that large Pt crystallites are formed in Pt/Al₂O₃-800, in line with what is observed by TEM.

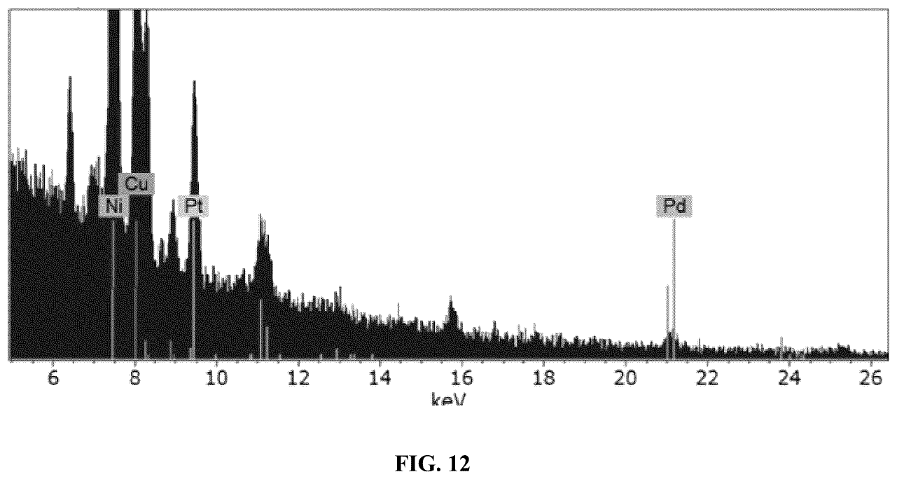

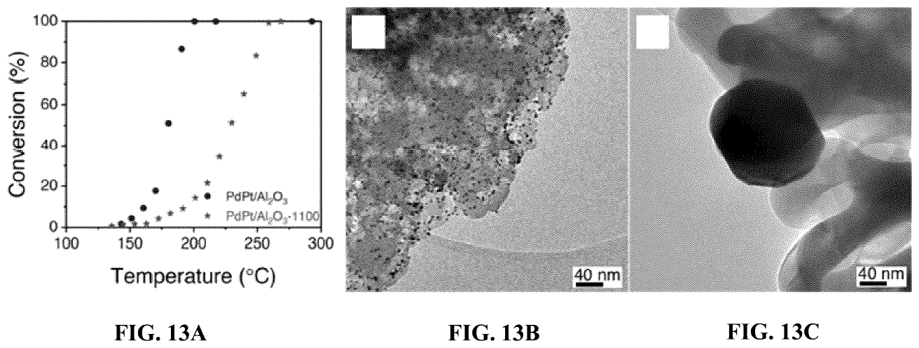

Best-fit extended X-ray absorption fine structure (EXAFS) models characterizing the as-prepared and aged samples, collected ex-situ, (Table 1, FIGS. 12 and 13) required only a metallic Pt-Pt scattering path to describe the samples. The Pt NP size could be estimated based upon the Pt-Pt coordination number (Table 1). (Jentys, A. Estimation of mean size and shape of small metal particles by EXAFS. PCCP 1, 4059-4063 (1999)). The EXAFS results, representing the average of all of the Pt in the sample, agreed with other characterization methods that indicated the Pt@Al₂O₃-800 catalyst maintained the small particle size while the Pt NPs sintered in the Pt/Al₂O₃-800 catalyst. The small discrepancies in the average particle size values between EXAFS and TEM can be attributed to a change in crystallinity and shape of the particles upon aging, and XAS measuring the average coordination environment of the Pt NPs.

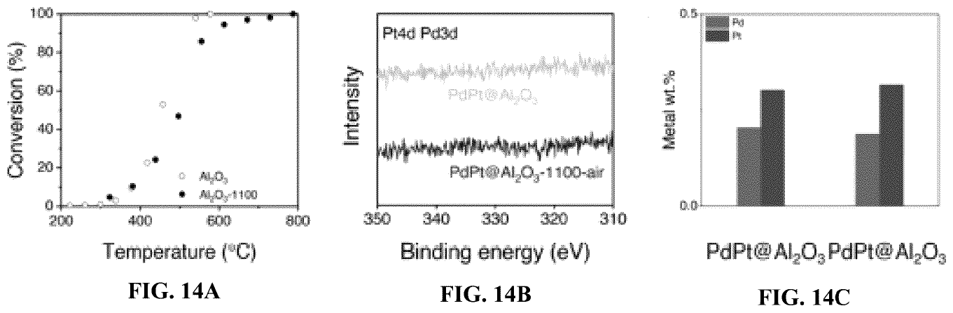

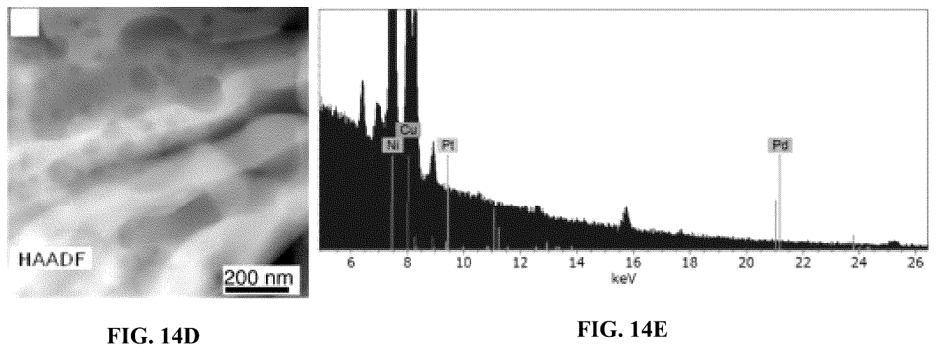

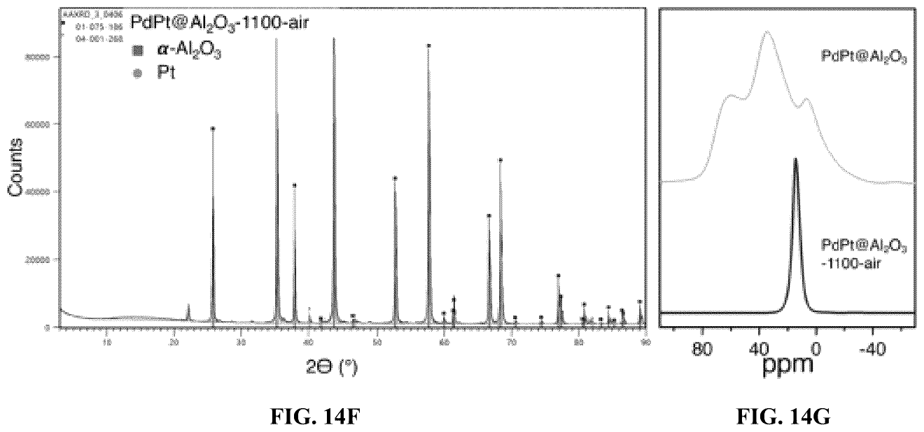

Finally, XPS characterization of the aged Pt@Al₂O₃-800 did not show signals attributable to Pt, suggesting that the NPs remained encapsulated under the alumina surface even after the hydrothermal aging (FIG. 14).

TABLE 1
EXAFS, TEM, and XRF results of as-synthesized and
800° C. aged Pt@Al₂O₃ and Pt/Al₂O₃.

| | | | | Pt size, | Pt size, | Pt wt. |
|---|---|---|---|---|---|---|
| | | | | nm | nm | % |
| Sample | α | σ², Å² | CN_{Pt-Pt} | (XAS) | (TEM) | (XRF) |
| Pt@Al₂O₃ | −0.005 ± 0.002 | 0.005 ± 0.001 | 10.1 ± 2.1 | 3.1 | 3.4 | 0.44 |
| Pt@Al₂O₃-800 | −0.005 ± 0.002 | 0.005 ± 0.001 | 11.0 ± 1.6 | 4.4 | 3.4 | 0.43 |
| Pt/Al₂O₃ | −0.005 ± 0.002 | 0.005 ± 0.001 | 9.2 ± 1.7 | 2.1 | 3.8 | 0.54 |
| Pt/Al₂O₃-800 | −0.003 ± 0.002 | 0.005 ± 0.001 | 11.6 ± 1.8 | >10 | 17.2 | 0.52 |

In the table above, α refers to symmetric expansion parameter; σ², mean-square deviation in path length; CN, coordination number; ΔE₀, inner potential correction (9.6±0.5 eV). A value of S₀²=0.79 was used, as described below.

Kinetic rate measurements for propene combustion, normalized by the Pt mass, demonstrated the similar activity between the two samples (FIG. 14(a)). The activation energies were 77±6 and 57±2 kJ-mol⁻¹ for Pt@Al₂O₃ and Pt/Al₂O₃, respectively, clearly suggesting that a larger number of active sites in the encapsulated sample compensate for the higher activation barrier. These results demonstrate that the encapsulation process leaves most of the metal available for reactivity, in contrast to previous works where encapsulated systems showed drastically lower activity compared to non-encapsulated counterparts due to the partial coverage of the catalytically active metal surface. (Mitchell, S., Qin, R., Zheng, N. & Perez-Ramirez, J. Nanoscale engineering of catalytic materials for sustainable technologies. Nat. Nanotechnol. 16, 129-139 (2021); Zhao, M. et al. Metal-organic frameworks as selectivity regulators for hydrogenation reactions. Nature 539, 76-80 (2016)).

In addition to propene combustion, performed were CO chemisorption and CO oxidation catalytic activity measurements to further investigate the reactivity of the system and the metal-support interface. From CO chemisorption, as-prepared Pt@Al₂O₃ and Pt/Al₂O₃ yielded similar Pt dispersion values of 8% and 9%, respectively, thus confirming that the encapsulation process did not lead to a loss in available reactive surface area. These values are lower than expected for 3.8 nm Pt NPs and may be attributed to the interaction with the amorphous alumina support given that a comparison sample of Pt/γ-Al₂O₃ gave a reasonable Pt dispersion of 16%. Other works have reported low CO adsorption by supported Pt NPs despite their high activity for CO oxidation. (Mao, X. et al. Epitaxial and Strong Support Interactions between Pt and LaFeO3 Films Stabilize Pt Dispersion. J. Am. Chem. Soc. 142, 10373-10382 (2020); Cargnello, M. et al. Control of Metal Nanocrystal Size Reveals Metal-Support Interface Role for Ceria Catalysts. Science 341, 771−773 (2013)). Remarkably, the dispersion of the aged Pt@Al₂O₃-800 sample remained similar to the fresh sample at 7.5%, whereas it drastically decreased to 0.3% in the aged Pt/Al₂O₃-800 sample. The CO chemisorption data is therefore in line with the above data on propene combustion, demonstrating the sintering-resistant properties of the encapsulated catalyst. Despite the lower CO chemisorption capacity than expected, both Pt@Al₂O₃ and Pt/Al₂O₃ samples were active for CO oxidation and showed similar rates (FIG. 12). The activation energy was found to be 43±9 and 56±18 kJ mol-1 for Pt@Al₂O₃ and Pt/Al₂O₃, respectively. Taken all together, these results further demonstrate that the activity-stability trade-off can be overcome using the present templated encapsulation strategy.

To further interrogate the surface of the encapsulated Pt NPs, performed were diffuse reflectance infrared Fourier transform spectroscopy (DRIFTS) measurements using CO as a probe molecule. After CO exposure, the Pt/Al₂O₃ sample showed a spectrum consisting of three convoluted vibrational contributions from CO adsorption at ˜2083, 2065, and 2040 cm⁻¹ (FIG. 14(b)). The two former features have been assigned to CO linearly bound to under-coordinated metallic Pt sites such as corners and edges, while the feature at 2040 cm⁻¹ to CO linearly bound to metallic Pt terraces. (Lu, J. et al. Coking- and Sintering-Resistant Palladium Catalysts Achieved Through Atomic Layer Deposition. Science 335, 1205-1208 (2012)). In the case of Pt@Al₂O₃, the spectrum was dominated by this latter feature, with minimal contributions from CO adsorbed on edge and corner sites. Stair et al. observed a similar effect in Pd/alumina catalysts that were coated with additional alumina layers by atomic layer deposition, (Id.) and the authors concluded that alumina was preferentially decorating under-coordinated sites on the metal particles. It is suggested that the same occurs in the Pt@Al₂O₃ sample, and that the Al₂O₃ preferentially interacts with under-coordinated Pt sites at edges and corners (FIG. 14(c)). Given that under-coordinated sites are more reactive towards oxygen, this characterization suggests that the alumina bonding in the Pt@Al₂O₃ sample may reduce the initiation of volatile PtO₂ species that are known to lead to sintering. (Id.)

Previous reports have suggested that defect sites in alumina such as penta-coordinated Al₃₊ sites (AlO₅) are able to stabilize metals and, thus, prevent them from sintering. (Kwak, J. H. et al. Coordinatively Unsaturated Al<sup>3+</sup>Centers as Binding Sites for Active Catalyst Phases of Platinum on γ-Al<sub>2</sub>O<sub>3</sub>. Science 325, 1670-1673 (2009)). Solid-state Al nuclear magnetic resonance (NMR) experiments were performed to test this hypothesis (FIG. 14(d)). NMR spectra of the as-prepared samples showed a large fraction of AlO₅ sites and resembled previously published results on amorphous alumina. (Kim, N., Bassiri, R., Fejer, M. M. & Stebbins, J. F. The structure of ion beam sputtered amorphous alumina films and effects of Zn doping: High-resolution 27A1 NMR. J. Non-Cryst. Solids 405, 1-6 (2014)). Although roughly half of the AlO₅ sites was preserved in the aged samples, the NMR spectra of the aged Pt@Al₂O₃-800 and Pt/Al₂O₃-800 catalysts were similar. This result indicates that AlO₅ or other specific alumina sites did not play a substantial role in stabilizing Pt against sintering.

Density functional theory calculations and sintering simulations were conducted to provide insights into the enhanced stability achieved through encapsulation. Periodic interfaces of Pt(100) and Pt(111) on γ-Al₂O₃ (100) were used to determine adhesion energies. The obtained adhesion energy of −71 meV·Å⁻²—average of the computed values for Pt(100) and Pt(111)—was then used in the sintering simulations. Specifically, the encapsulated spherical particles were described with a chemical potential according to equation 1:

μ−μ_{bulk}=2(γ+γ_{adh})Vₘ/r (eq. 1)
according to the Gibbs-Thomson equation and accounting for adhesion on the entire surface. Here, γ is the surface energy, γadh is the adhesion energy, r is the particle radius and Vₘ is the molar volume of Pt (15.1 Å³ per atom). The supported particles were described by spherical caps with a height-to-width ratio given by equation 2:

1−|γ_{adh}/(2γ) (eq. 2)

The chemical potential of these particles is given by equation 3 (Plessow, P. N. & Campbell, C. T. Influence of Adhesion on the Chemical Potential of Supported Nanoparticles as Modeled with Spherical Caps. ACS Catal. 12, 2302-2308 (2022)):

μ−μ_{bulk}=2γVₘ/r (eq. 3)

The particle size distributions were described by a normal distribution with experimentally observed mean particle size and standard deviation values. Sintering through Ostwald ripening via volatile PtO₂ (g) was simulated using a mean-field model. (Campbell, C. T. & Mao, Z. Chemical Potential of Metal Atoms in Supported Nanoparticles: Dependence upon Particle Size and Support. ACS Catal. 7, 8460-8466 (2017)). The fraction of reactive surface collisions of PtO₂(g) with the particles is given by a sticking coefficient S, where S=1 indicates that every collision leads to PtO₂ sticking to the surface. For Pt/Al₂O₃, it is expected that S=1, in accordance with the properties of clean Pt-surfaces. The reduced adsorption and emission of PtO₂(g) in Pt@Al₂O₃ that effectively leads to fewer collisions with the encapsulated particles is described by a reduced effective sticking coefficient, which is denoted S_{eff}.

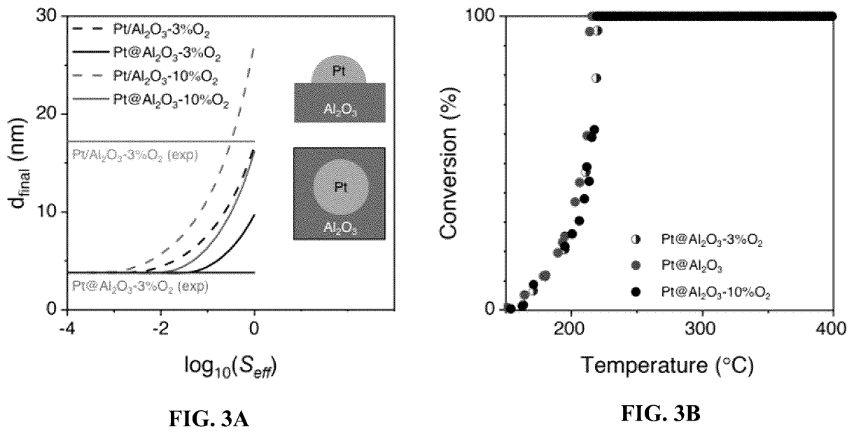

FIGS. 3(a) and 3(b) illustrate example properties of Pt@Al₂O₃ according to embodiments. FIG. 3(a) illustrates Simulated average Pt diameter, da_{final}, after aging at 800° C. for 2 h in 3 vol. % and 10 vol. % O₂ as a function of the effective sticking coefficient S_{eff} for Pt@Al₂O₃ and Pt/Al₂O₃. Grey and blue lines indicate the experimentally observed final Pt diameter sizes for Pt/Al₂O₃ and Pt@Al₂O₃ after aging in 3 vol. % O₂; FIG. 3(b) illustrates Propene combustion activity for as-prepared and aged Pt@Al₂O₃. Pt@Al₂O₃-3% O₂ is the catalyst aged at 800° C. for 2 h in 3 vol. % O₂, 5 vol. % steam, balance Ar (40 ml/min total flow). Pt@Al₂O₃-10% is the catalyst aged at 800° C. for 2 h in 10 vol. % O₂, 5 vol. % steam, balance Ar.

More particularly, FIG. 3(a) shows sintering as a function of S_{eff} The surface energy of Pt was set to 110 meV·Å⁻² to obtain a simulated final diameter of 16.6 nm for Pt/Al₂O₃ after 2 hours at 800° C. in 3 vol. % O₂, which is in line with the experimental value of 17.2 nm. For sintering in 10 vol. % O₂, the simulations predicted significantly increased sintering, with a final Pt NP average diameter for Pt/Al₂O₃ greater than 25 nm (FIG. 3(a)), in line with the hypothesis of PtO₂(g) being the species responsible for sintering. At S_{eff}=1, the simulated sintering in the Pt@Al₂O₃ catalyst was significantly reduced compared to the Pt/Al₂O₃ sample due to increased adhesion between the Pt particles and the alumina in the encapsulated sample geometry. However, the predicted size of Pt@Al₂O₃ after aging in 3 vol. % O₂ matches the experimental results only for S_{eff} smaller than 0.1, indicating that further stabilization mechanisms are at play in this catalyst. To explore the effect of a higher oxygen concentration, Pt@Al₂O₃ was aged in 10 vol. % O₂. The catalyst still maintained its activity (FIG. 3(b)), in agreement with the computational model where the encapsulation geometry leads to decreased PtO₂(g) vapor exchange, as expressed by a value of S_{eff} at least smaller than 0.01 in 10 vol. % O₂. The stability of the encapsulated Pt can therefore be explained by the combination of the higher adhesion energy and the lower rate of reactive surface collisions of PtO₂(g) that translate into slower sintering when Pt is embedded in the alumina framework. This result is also in line with DRIFTS measurements, suggesting that the stabilization of under-coordinated Pt sites by alumina may reduce S_{eff} as reflected in the sintering simulations.

To compare the effect of diffusion limitations on PtO₂ sintering and the catalyst's reactivity, estimated was the oxygen pressure drop Δₚ across the encapsulating material during the propene combustion reaction, assuming identical diffusion constants for PtO₂, O₂ and propene. Under steady-state conditions, the rate of O₂-consumption per particle (turn over frequency) equals the flux of O₂(g) through the encapsulating material. The oxygen pressure drop can then be calculated according to Fick's first law. From the conducted experiments, the highest Δₚ that could occur in this system was determined as 4.3*10⁻⁵ bar, which is only 0.1% of the total oxygen pressure of 3*10⁻² bar. Such a small oxygen pressure drop causes only a negligible effect on the catalyst's activity. An analogous result can be found for propene: considering the stoichiometry of the propene combustion reaction, the pressure drop reduces to 0.96*10⁻⁵ bar. Relative to the partial pressure of propene, 1.5*10⁻³ bar, this is again a negligible pressure drop of 0.6%. For Pt sintering, however, the situation is different, since the pressure of PtO₂(g) is significantly smaller, typically on the order of 10⁻⁹ bar. In this case, a small absolute pressure drop will already be of the same order of magnitude as the total PtO₂(g) pressure and will thus be significant for sintering. TIn conclusion, diffusion limitations are important for PtO₂ sintering, but do not affect the transport of propene and oxygen to the active sites and, therefore, the reactivity.

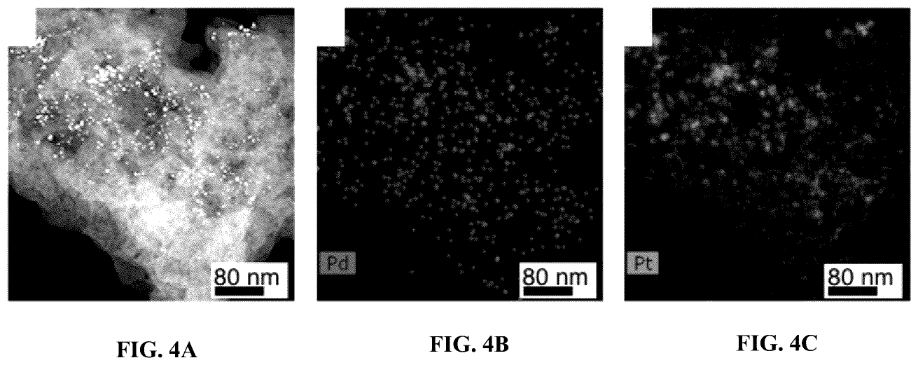

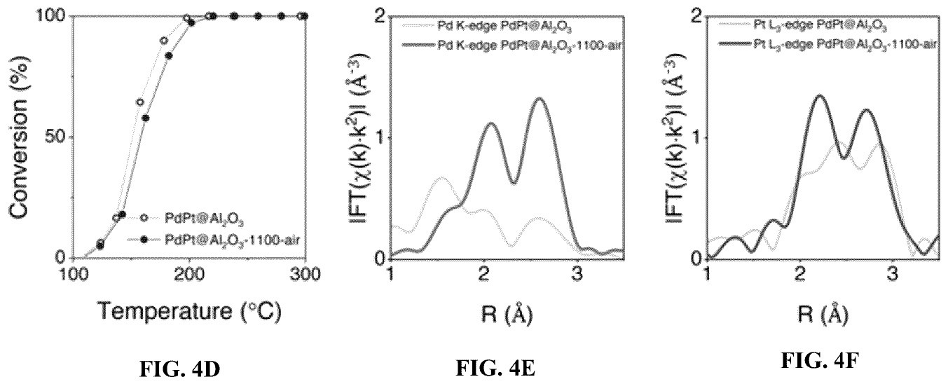

FIGS. 4(a) to 4(f) illustrate example aspects of as-synthesized PdPt@Al₂O₃ according to embodiments. FIGS. 4(a) to 4(c) illustrate a representative HAADF-STEM image and corresponding EDS maps (Pd-K edge and Pt-L edge) of as-synthesized PdPt@Al₂O₃; FIG. 4(d) illustrates Propene combustion activity for fresh PdPt@Al₂O₃ and 1,100° C. aged PdPt@Al₂O₃. Aging performed at 1,100° C. for 5 h in air with 10 vol. % steam (40 ml/min total flow); FIGS. 4(e) and 4(f) illustrate Magnitude of the Fourier transform (FT) of the e) Pd K-edge and f) Pt L3-edge EXAFS of the fresh (light colored traces) and 1,100° C. aged (dark colored traces) catalysts.

More particularly, one object is to further increase the thermal stability of the encapsulated sample by the addition of Pd to the catalyst formulation. Supported Pd catalysts are known to be more stable than Pt under oxidizing conditions due to the much lower volatility of PdO. (Goodman, E. D. et al. Catalyst deactivation via decomposition into single atoms and the role of metal loading. Nat. Catal. 2, 748−755 (2019)). Embodiments therefore extended the materials synthesis approach to 3.5 nm palladium-platinum (PdPt) bimetallic nanoparticles with a Pd/Pt atomic ratio of 1. HAADF-STEM characterization and energy-dispersive X-ray spectroscopy (EDS) mapping of the as-prepared sample confirmed the co-location of Pd and Pt in the encapsulated NPs (FIGS. 4(a) to 4(c)). The EDS quantification of 0.06 at. % for both Pd and Pt is in excellent agreement with the synthesis of PdPt nanoparticles with a 1/1 atomic ratio. The total weight loading of the metals of 0.86 wt. % quantified by EDS is higher than the overall metal loading of 0.5 wt. % confirmed by XRF. This result is due to the fact that in addition to alumina grains containing metal nanoparticles, the present synthesis also forms bare alumina. As for Pt@Al₂O₃, the activity of the 800° C.-aged PdPt@Al₂O₃(labeled PdPt@Al₂O₃-800) was similar to that of the as-prepared catalyst, as evidenced by the light off-curves.

To test the stability of this material under more demanding conditions relevant for industrial applications, it was aged at 1,100° C. for 5 h in air (˜21 vol. % O₂) and 10 vol. % steam to simulate environments for emission control catalysts. The sample maintained its activity as evidenced by the overlapping light-off curves in FIG. 4(d). A control PdPt/Al₂O₃ sample prepared by deposition of the same PdPt NPs onto the alumina support deactivated after the severe aging treatment and once more showed drastic sintering of the metal NPs, highlighting that the encapsulation was the reason for the stable performance of the PdPt@Al₂O₃ sample. Pure Pt@Al₂O₃ and Pd@Al₂O₃ catalysts also deactivated, further demonstrating the importance of alloying, in agreement with previous findings. The metal-free support was much less active after the 1,100° C. aging, again indicating that the metal phase was responsible for the maintained performance.

XPS characterization of the as-synthesized and 1,100° C. aged PdPt@Al₂O₃ did not show observable Pd 3d_{3/2}, Pd 3d_{5/2}, Pt 4d_{3/2}, or Pt 4d_{5/2} signals, indicating that the metals remained encapsulated inside the alumina after aging. XRF results confirmed that there was no metal loss in the catalyst after aging. While it was not possible to image any discrete metal NPs using STEM on the 1,100° C. aged catalyst likely due to the increased alumina density after aging, best-fit EXAFS models were consistent with the presence of metal NPs with direct interaction between Pt and Pd (FIGS. 4(e) and 4(f)). The coordination numbers indicate that the as-prepared catalyst comprises a core-shell metal geometry consisting of a platinum-palladium core surrounded by a palladium oxide shell that is transformed into bimetallic alloy NPs upon the aging treatment. The EXAFS results of the supported PdPt/Al₂O₃ catalyst also show the transformation of core-shell structures into PdPt bimetallic alloys with similar coordination numbers. Despite the similar EXAFS results, the PdPt@Al₂O₃ catalyst maintained its activity after the aging treatment, while PdPt/Al₂O₃ deactivated. It is thus hypothesized that the stability of PdPt@Al₂O₃ is related to the metal-support interactions between the nanoparticles and encapsulating alumina layers. To further understand the nature of the encapsulated catalyst, performed were XRD and solid-state NMR characterizations. XRD and NMR patterns showed that the amorphous Al₂O₃ in the as-prepared PdPt@Al₂O₃ sample crystallized into the α phase. The thickness of the alumina layer estimated by STEM-electron energy loss spectroscopy from the log-ratio method (Malis, T., Cheng, S. C. & Egerton, R. F. EELS log-ratio technique for specimen-thickness measurement in the TEM. Journal of Electron Microscopy Technique 8, 193-200 (1988)) of the low-loss portion of the EEL spectrum image was 86±32 nm. It is suggested that the HAADF signal from the metal particles in the aged catalyst was below the detection limit given the thick alumina background following the high-temperature aging treatment. Finally, performed were long-term aging experiments under alternating reducing-oxidizing conditions following accepted protocols. (Rappé, K. G. et al. Aftertreatment Protocols for Catalyst Characterization and Performance Evaluation: Low-Temperature Oxidation, Storage, Three-Way, and NH3-SCR Catalyst Test Protocols. Emission Control Science and Technology 5, 183-214 (2019)). The sample completely maintained its activity, further demonstrating the superiority of the present method for sintering-resistant catalysts. Overall, the catalytic and characterization data demonstrate that the encapsulation prevents the NPs from sintering, thus maintaining the catalytic activity in the aged sample at the same level as in the fresh catalyst.

In conclusion, an alumina-encapsulated Pt catalyst according to embodiments demonstrates high stability under hydrothermal aging conditions relevant for exhaust emission control. Unlike conventional encapsulated systems, this material does not suffer from the activity-stability tradeoff and shows same rates compared to a conventional supported catalyst of the same composition. The NP stabilization by encapsulation is explained by the combination of the higher adhesion energy and the lower rate of reactive surface collisions of PtO₂(g) that translate into slower sintering when Pt is embedded in the alumina framework. This material design strategy was extended to PdPt NPs to prepare a catalyst that is stable under even more demanding conditions, i.e. 1,100° C. aging in air and 10 vol. % steam. This encapsulation approach can be broadly applied to other metals and metal oxide supports for applications where metal sintering is the main cause of catalyst deactivation.

### Example Methods

### Synthesis of Pt Nanoparticles (NPs)

All chemicals were purchased from Sigma Aldrich. Pt nanoparticles (NPs) were prepared by thermal decomposition of platinum (II) acetylacetonate (Pt(acac)2, 99.98%) via colloidal synthesis using standard Schlenk techniques and a previously reported procedure. 10 mL of trioctylamine (TOA, 95%), 0.66 mL of 1-oleylamine (OLAM, 70%), and 2.5 mL of oleic acid (OLAC, 90%) were added to 79 mg of Pt(acac)2 in a three-neck flask. The reaction content was degassed (<2 Torr) for 15 min at room temperature. Then 220 μL of trioctylphosphine (TOP, 97%) were added to the reaction mixture. The flask was further degassed at 120° C. for 30 min, and it was then flushed with nitrogen, heated to 350° C. at a rate of ˜20° C. min-1 and kept at this temperature for 15 min. After cooling down to room temperature, the reaction content was split into two centrifuge tubes and each was washed with a mixture of 10 mL isopropyl alcohol and 20 mL ethanol and recovered by centrifugation (8000 rpm, 3 min). Finally, the NPs were suspended in hexanes. The synthesis of Pd NP was performed with 77 mg Pd(acac)2, 4.5 mL ODE, 5.5 mL Tetradecene, 1.66 mL OLAM, and 0.567 mL TOP. The reactor content was degassed at 50° C. for 30 min, heated to 225° C. under nitrogen and kept for 30 min. For the PdPt NP synthesis, 3.3 mL of 1-oleylamine, 1.6 mL of oleic acid, and 40 mL of 1-Octadecene were added to 200.7 mg of Pt(acac)2 and 157 mg of Pd(acac)2 in a three-neck flask. The reaction content was degassed for 30 min at room temperature. Then 550 μL of trioctylphosphine were added to the reaction mixture. The flask was further degassed at 50° C. for 30 min, and it was then flushed with nitrogen, heated to 300° C. at a rate of ˜20° C. min⁻¹ and kept at this temperature for 15 min. The NPs were washed following the procedure described above.

### Synthesis of Pt@POF

POF was prepared using standard air-free Schlenk techniques following a previously reported procedure. 9.3 g of melamine (99%, Acros Organics) and 15 g of terephthalaldehyde (99%, Acros Organics) were added to 495 mL of dimethyl sulfoxide (DMSO, 99.9%, Fisher) in a 3-neck flask. The content was degassed at room temperature for 15 min, and then flushed with nitrogen, heated to 180° C. at a rate of ˜20° C. min-1 and kept at this temperature for 72 hours. The solid product was washed with acetone three times and dried under vacuum (˜150 torr) at 80° C. for 24 h, with a yield of 64%. 8 mg of Pt NPs in hexanes was added dropwise to 400 mg POF dispersed in 10 mL of a 1 to 9 mixture of 2-methyl tetrahydrofuran (99%, Sigma Aldrich) and hexanes under vigorous stirring. The mixture was stirred for 20 min to allow the NPs to adsorb to the support and the solvents were then removed by centrifugation (8000 rpm, 3 min). Colorless supernatants were observed for each solution indicating complete adsorption of the NPs. The powder was dried at 80° C. for 3 h. Organic ligands were removed by calcination in air at 300° C. for 20 min. The particle encapsulation was then performed by growing an additional POF layer around the pre-formed Pt/POF material. 0.75 g of Pt/POF were added to 1.18 g melamine and 1.87 g terephthalaldehyde dissolved in 61 mL of DMSO. The mixture was heated to 180° C. as above but for 24 h. The final material was washed three times with acetone as described before to obtain Pt@POF material with a 64% yield.

### Synthesis of Pt@A/203

18 g of Al(NO₃)3·9H₂O (>98%, Sigma Aldrich) were dissolved in 100 mL of ethanol. 1.2 g of Pt@POF were added to the solution. The mixture was sonicated for 10 min, then ethanol was slowly removed in a rotary evaporator at 60° C. (water bath temperature) at 900 mbar for 1 h and then at 150 mbar for 1 h. The material was dried under vacuum (˜150 torr) at 80° C. for 24 h. The final product was obtained by calcining the sample at 600° C. for 5 h with a ramp rate of 0.5° C. min-1. This procedure resulted in purely mesoporous Al₂O₃. For the synthesis of micro-/mesoporous Al₂O₃, an ammonia solution in ethanol (24 mL of ethanol mixed with 18 mL of ammonia solution (2 M in ethanol, Sigma Aldrich) was added to the sample after removing ethanol in the rotary evaporator, before removing the ammonia solution again using the procedure described above.

### Synthesis of Supported Pt and PdPt

Appropriate amounts of Pt or PdPt NPs were added to alumina support dispersed in hexanes under vigorous stirring to achieve a nominal metal loading of 0.5 wt. %. The mixtures were stirred for 20 min to allow the NPs to adsorb to the support and the catalysts were recovered by centrifugation (8000 rpm, 3 min). Colorless supernatants were observed for each solution indicating complete adsorption of the NPs. The powders were dried at 80° C. for 3 h and sieved below 180 μm grain size. Organic ligands were removed by fast calcination of the catalysts at 700° C. for 30 s. (Cargnello, M. et al. Efficient Removal of Organic Ligands from Supported Nanocrystals by Fast Thermal Annealing Enables Catalytic Studies on Well-Defined Active Phases. J. Am. Chem. Soc. 137, 6906-6911 (2015)).

### Catalyst Characterization

Bright-field transmission electron microscopy (TEM) was performed on a FEI Tecnai TEM operating at 200 kV.

High-angle annular dark-field scanning transmission electron microscopy (HAADF-STEM) images were acquired using a FEI/Thermo Fischer Titan called the TitanX operating at 300 kV at the National Center for Electron Microscopy (NCEM) facility of the Molecular Foundry at Lawrence Berkeley National Laboratory. For powder samples, lacey C/Cu grids were shaken with the catalyst powder to prepare samples for imaging.

STEM tomography was acquired at 300 kV using a FEI/Thermo Fisher Titan called the TitanX at NCEM with a 7 mrad semi-convergence angle and a beam current of ˜3 pA. Images were acquired at every 2-degree tilt from −70 to +68 degrees. The tilt series was aligned using tomviz 1.9.0. The reconstruction was accomplished using the SART algorithm implemented in the Astra toolbox version 1.9.0 dev11 with 350 iterations. Visualization of the tomogram was accomplished using tomviz 1.9.0.

STEM-EELS data was collected on the TEAM I instrument at the Molecular Foundry, which is a double-corrected TEM on the Thermo Fisher Titan platform with a Gatan Continuum GIF. Electron Energy Loss Spectra were recorded on a post-GIF K3 detector in electron counting mode with a dispersion of 0.18 eV/pixel. Sample thickness maps were acquired with 300 keV electrons with a 17.1 mrad convergence semi angle and 65 mrad collection semiangle. Spectrum images was acquired with an 80 pA probe current, 50 millisecond dwell time, and 2 nm pixels with 16×16 sub-scanning of each STEM pixel. Sample thickness was estimated from the Log-ratio method of the low-loss portion of the EEL spectrum image.

N₂ physisorption experiments were carried out on a Micromeritics 3Flex instrument. Powders were degassed under vacuum at 90° C. for 1 h and then 300° C. for 5 h prior to N₂ adsorption at liquid nitrogen temperature. Micropore volume was calculated using NLDFT Advanced PSD using slit geometry and carbon model.

Thermogravimetric analysis was performed on a TA Instruments TGA-500. Pt nanoparticles in hexane solutions were heated at a ramp rate of 10° C. min-1 under a flow of 45 mL min⁻¹ of air. Powder catalysts were pretreated at 300° C. in air and then heated to 800° C. with a ramp rate of 10° C. min-1.

XPS measurements were carried out in a PHI VersaProbe I and III Scanning XPS Microprobe equipped with a hemispherical electron analyser with monochromatic Al(Kα) radiation (1486.6 eV) and with an argon ion sputter gun. All samples were deposited on conductive carbon tabs on an aluminum holder, outgassed at 10⁻⁴ mbar, and then transferred to the ion-pumped analysis chamber. Pressure was kept below ˜5×10˜7 Pa during data acquisition. The incident X-ray spot size was 100 μm and an excitation of 100 W at 20 kV was used for the radiation source. The binding energies were referenced to the C1s peak (284.8 eV) to account for charging effects. Given the Al Kα radiation energy (1486.6 eV) of the XPS source and a Pt 4d binding energy of 315 eV, Pt 4d photoelectrons are emitted with kinetic energy of 1171.6 eV. This corresponds to an escape depth of ˜˜1-2 nm. (Shinotsuka, H., Tanuma, S., Powell, C. J. & Penn, D. R. Calculations of electron inelastic mean free paths. X. Data for 41 elemental solids over the 50 eV to 200 keV range with the relativistic full Penn algorithm. Surf. Interface Anal. 47, 871-888 (2015)).

XRF fluorescence measurements were collected on a XEPOS X-ray spectrometer. The spectrometer is equipped with a Solid-State Detector (SSD) and samples are run at 4 different energies.

XRD samples were ground to fine powders, put on amorphous silicon wafers, and pressed down into the holders with a thin film of silicon grease. The samples were then placed on a Miniflex 600. The XRD instrument has Bragg Brentano geometry equipped with a Solid state 1 D detector. Samples were scanned for 1.5 h in order to get the desired signal to noise ratio.

All NMR data were collected with a Varian Inova 600 spectrometer (14.1 T field, 156.25 MHz for 27A1), using a Varian “T3” probe with a 3.2 mm, zirconia rotor spinning at 20 kHz. Background signal from the rotor was negligible. Spectra are referenced to 0.1 M aqueous Al(NO₃)₃ at 0 ppm. Radiofrequency power was about 100 kHz; single pulse acquisition was used with 0.2 s pulses, corresponding to a radiofrequency tip angle of about 200 for solids with significant quadrupolar coupling. Relaxation delays of 1 s between pulses allowed averaging of typically 40,000 acquisitions, yielding very high signal to noise ratios. Data collected with delays of 10 and 60 s showed no or only minor increases in intensity. Differential relaxation among signals for different Al sites was generally negligible, except in several samples that appeared to contain significant proportions of both the AlO₅-rich amorphous phase and the AlO₅-poor crystalline transition alumina, which relaxed slightly more slowly. Relative proportions of four, five, and six-coordinated Al (AlO⁴, AlO₅, AlO₆) were estimated by fitting of ½- 3/2 spinning sidebands, which are less affected by second-order quadrupolar broadening than are central transition resonances.

X-ray absorption spectra of platinum catalysts were recorded at Stanford Synchrotron Radiation Lightsource (SSRL, California, USA) at a wiggler beamline 9-3 using a liquid nitrogen cooled Si(220) double-crystal monochromator with harmonic rejection and focusing optics. The storage ring was operated at 3 GeV with a ring current of 494-500 mA in top-off mode. The beam cross-section was 1 mm×4 mm. The X-ray absorption near-edge structure (XANES) and extended X-ray absorption fine structure (EXAFS) spectra were recorded at the Pt LIII-edge (11,564 eV) and Pd K-edge (24,350 eV) in fluorescence mode, using a PIPS diode. Transmission spectra of Pt or Pd reference foil were collected simultaneously for internal energy calibration using nitrogen or argon-filled ion chambers. Samples typically considered of 60 mg of catalyst was pressed into a 7 mm in diameter pellet and were mounted at 45 degrees to the incident beam. Sample mass was specifically calculated to minimize self-absorption during the fluorescence measurement.

Ex-situ EXAFS spectra were acquired at room temperature. The XAS spectra were energy-calibrated, merged, and normalized, and the resulting EXAFS were extracted using the Athena interface of the Demeter software package. (Ravel, B. & Newville, M. ATHENA, ARTEMIS, HEPHAESTUS: data analysis for X-ray absorption spectroscopy using IFEFFIT. J. Synchrotron Radiat. 12, 537-541 (2005)). EXAFS modeling performed using the Artemis interface of the Demeter software. (Id.) S02 was determined to be 0.79±0.06 for the Pt LIII-edge from fitting Pt foil. Models were fit in R-space using k1, k2, and k3-weightings. For the Pt catalyst samples, the EXAFS was modeled with a R-range of 1.9-4.9 Å and a k-range of 3.6-14.3 Å-1. The Pt-Pt scattering path was simulated using Feff in Artemis based upon a Pt foil cif input file (ICSD code 243678). The EXAFS data from all catalysts were modeled simultaneously to minimize errors. The fitting was done using a symmetric expansion parameter a. Average size of Pt from the fitted EXAFS data was calculated using the Pt-Pt coordination numbers from the first scattering path and fitting parameters determined in the previously published work.22 X-ray absorption spectra of palladium-platinum catalysts were collected during a separate beam time shift at 9-3. EXAFS data of the PdPt catalysts was modelled using S02 of 0.78 and 0.81 for the Pt L3-edge and Pd K-edge, respectively, with a R-range of 1.2-3.0 Å (Pd) and 1.7-3.2 Å (Pt); a k-range of 2.7-12.5 Å⁻¹ (Pd) and 3.1-12.0 Å-1 (Pt). The Pd-0, Pd—Pd, Pd—Pt, Pt-Pd, and Pt-Pt scattering paths were simulated using Feff in Artemis based upon a Pt foil cif input file (ICSD code 243678), Pd foil cif input file (ICSD code 77885), and PdO cif input file (ICSD code 24692). PdPt alloys were made by substituting Pt for Pd in the bulk Pd structure for Pd-Pt coordination and Pd for Pt in the bulk Pt structure for Pt-Pd coordination. For each catalyst, the EXAFS data from the two edges were modeled simultaneously to minimize errors.

Diffuse reflectance infrared Fourier transform spectroscopy (DRIFTS) measurements were performed using a Thermo Fisher Nicolet iS50 Fourier transform infrared spectrometer with a liquid nitrogen cooled mercury cadmium telluride detector. Powders were loaded into a Harrick Praying Mantis DRIFTS reaction cell. Measurements were carried out at room temperature and 64 spectra were averaged per spectra to improve signal-to-noise. Prior to the measurements, catalysts were pretreated for 30 min under O₂ (20 vol. %)/He at 300° C. (ramp rate of 10° C. min⁻¹), 10 min under He, and H2 (5 vol. %)/He for 30 min.

### Catalytic Performance Evaluation

Catalytic light-off curve experiments were conducted under atmospheric pressure in a U-shaped quartz glass reactor with a 1 cm inner diameter using 150-200 mg of catalyst powder. The catalyst bed temperature was measured using a K-type thermocouple inserted in the middle of the reactor bed. Reaction mixture consisted of 0.15 vol. % C3H6, 3 vol. % O₂ and 5 vol. % steam. The total flow rate was 40 mL min⁻¹ with argon used as balance. Platinum samples were aged in the reaction mixture either with 3 or 10 vol. % O₂. Platinum, palladium-platinum and palladium catalysts were also aged either in the reaction mixture with 3 vol. % O₂ and 5 vol. % steam or in air with 10 vol. % steam at 1,100° C. for 5 h. Additionally, the palladium-platinum samples were aged at 900° C. for 50 h under reducing-oxidizing alternating conditions as presented Table S5. Prior to catalytic activity testing of fresh materials, each catalyst was oxidized for 30 min under 40 mL min-1 flow of 5 vol. % O₂ at 300° C. (ramp rate of 10° C. min-1), flushed with 40 mL min⁻¹ Ar for 10 min and reduced in 40 mL min⁻¹ of 5 vol. % H2. Performance of aged catalysts was measured directly after aging. Kinetic experiments were conducted in a temperature range of 130-200° C. using ˜25 mg of catalyst powder diluted with 200 mg of inert SiC and loaded into the reactor between two layers of granular acid-washed quartz. Gas-hourly space velocity (GHSV) was adjusted to maintain propene conversion below 5%.

### Density Functional Theory (DFT) Calculations and Sintering Simulations

Calculations were carried out with the PAW method and the VASP 5.4.1 program package (Kresse, G. & Joubert, D. From ultrasoft pseudopotentials to the projector augmented-wave method. Phys. Rev. B 59, 1758-1775 (1999); Kresse, G. & Furthmuller, J. Efficient iterative schemes for ab initio total-energy calculations using a plane-wave basis set. Phys. Rev. B 54, 11169-11186 (1996)), using the PBE-D3 functional (Perdew, J. P., Burke, K. & Ernzerhof, M. Generalized Gradient Approximation Made Simple. Phys. Rev. Lett. 77, 3865-3868 (1996); Grimme, S., Antony, J., Ehrlich, S. & Krieg, H. A consistent and accurate ab initio parametrization of density functional dispersion correction (DFT-D) for the 94 elements H-Pu. J. Chem. Phys. 132, 154104 (2010)), an energy cutoff of 400 eV and Gaussian smearing with a width of 0.1 eV. The interface between Pt particles and the Al₂O₃ support was modelled using periodic Pt(100) and Pt(111) surfaces as well as the dehydroxylated 100-surface of the commonly used γ-Al₂O₃ model. (Digne, M., Sautet, P., Raybaud, P., Euzen, P. & Toulhoat, H. Use of DFT to achieve a rational understanding of acid-basic properties of γ-alumina surfaces. J. Catal. 226, 54-68 (2004)). The γ-Al₂O₃(100) surface has previously been used to model AlO₅-sites. Supercells for Pt(100)/γ-Al₂O₃(100) and Pt(111)/γ-Al₂O₃(100) were constructed based on the unit cell of γ-Al₂O₃(100) (5.56 Å×8.35 A) resulting in a small lattice mismatch for Pt. A (2×3)-Pt(100) on (1×1)-γ-Al₂O₃(100) supercell was used giving a lattice mismatch smaller than 0.5% and an adhesion energy of −76 meV/Å². For Pt(111), a (2×5√3)-Pt(111) on (1×³)-γ-Al₂O₃(100) supercell was used, giving a lattice mismatch of 5% and an adhesion energy of −66 meV/Å². Additionally, a (2×7√3)-Pt(111) on (1×4)-γ-Al₂O₃(100) supercell was used, giving a lattice mismatch of −0.5% and an adhesion energy of −69 meV/Å². A y-centered (6×4×1) k-point grid was used for Pt(100)/γ-Al₂O₃(100) and a (5×1×1) and (6×1×1) k-point grid for the two Pt(111)/γ-Al₂O₃(100) interfaces. The final adhesion energy used in the sintering simulations was taken to be −71 meV·Å⁻², which is approximately the average of the computed values for Pt(100) and Pt(111).

The accessible surface area for sintering of the spherical caps is the total surface area minus the interface area, while for the spherical, encapsulated particles, the entire surface is assumed to be accessible. As the same radii were employed, the two different particle shapes lead to slightly different volumes and therefore slightly different number of atoms. Also tests were performed using spherical caps with the same volume as the spheres, which increases their mean diameter from 3.8 nm to 4.1 nm. The sintering simulations using these particle size distributions gave very similar results, indicating that choosing either one of the two assumptions does not result in significant differences. The PtO₂(g) pressure of bulk Pt was extrapolated using the formula based on experimental measurements given by Tebben (Schafer, H. & Tebben, A. Gleichgewichtsmessungen im System Platin-Sauerstoff Gasförmiges Platindioxyd. Z. Anorg. Allg. Chem. 304, 317-321 (1960)): log 10(p(PtO₂)/p(O₂))=0.374-8757*K/T. The particle size distributions were described by a normal distribution with a mean diameter of 3.8 nm and r=0.5 nm and were discretized using 10000 bins and the simulations were run using an average time steps of 1.39 s.

Example Commercial Applications: The present embodiments could be used by companies to make commercial catalysts for automotive catalytic converters. More broadly, these materials target commercial applications, such as emission control technologies, involving noble metal catalysts that are exposed to harsh and high temperature working conditions causing the metals to sinter. It is desirable to test the performance and stability under industrial conditions.

Advantages and improvements over existing methods, devices or materials: An example advantage of a material according to embodiments is its superior thermal stability compared to conventional systems While the conventional catalysts show a decreased performance (i.e. decreased activity in combusting harmful emission gases) after being exposed to harsh conditions, the present material maintains high performance.

### Supplemental Information

FIGS. 5(a) to 5(e) illustrate example characterization of Pt@Al₂O₃ according to embodiments. FIG. 5(a) illustrates example aspects of TGA upon heating the sample in air to 700° C. FIG. 5(b) illustrates example N₂ physisorption isotherm. FIG. 5(c) illustrates example pore size distribution. FIGS. 5(d) and 5(e) illustrates example characterization of micro/mesoporous Pt@Al₂O₃.

FIGS. 6(a) to 6(e) illustrate further example characterization of Pt/Al₂O₃ according to embodiments. FIG. 6(a) is an example transmission electron microscopy image. FIG. 6(b) is an example particle size distribution. FIGS. 6(c) and 6(d) are example XPS representations of (c) Pt 4d3/2 and Pt 4d5/2 and (d) Al2p and Pt 4f5/2 overlapping signals. FIG. 6(e) provides example light-off curves of fresh Pt@Al₂O₃ and Pt-free Al₂O₃ support. Reaction mixture: 0.15 vol. % C₃H₆, 3 vol. % O₂, and 5 vol. % steam (balance Ar).

FIGS. 7(a) and 7(b) illustrate further example characterization of Pt/Al₂O₃ according to embodiments. FIG. 7(a) is an example XRD characterization and FIG. 7(b) is an example TEM characterization of Pt/Al₂O₃ calcined at 600° C. for 5 hours. Highlighted peaks in the XRD pattern in FIG. 7(a) are due to metallic Pt. After calcination, the average Pt NP size increased from 3.8 nm to 23.3 nm.

FIGS. 8(a) to 8(e) illustrates further example characterization of Pt/Al₂O₃ according to embodiments. FIG. 8(a) illustrates Light-off curve measurements of fresh and aged Pt/Al₂O₃. Reaction conditions: 0.15 vol. % C3H6, 3 vol. % O₂, and 5 vol. % H₂O. Aging performed in the reaction mixture at 800° C. for 2 h. FIGS. 8(b) and 8(c) are representative TEM images and FIGS. 8(d) and 8(e) are example particle size distributions of the fresh and aged catalysts, respectively.

FIGS. 9(a) to 9(d) illustrate example EXAFS and XPS characterization of as-prepared and aged Pt@Al₂O₃ and Pt/Al₂O₃ according to embodiments. FIG. 9(a) is a graph illustrating magnitude and imaginary part of the Fourier Transform of the Pt L3-edge data (dark colored traces) and fits (light colored traces); FIG. 9(b) illustrates (c(k),k3) data (dark colored traces) and fits (light colored traces). FIG. 9(c) and 9(d) represent XPS of Pt@Al₂O₃-800.

FIGS. 10(a) and 10(b) illustrate further example characterization of Pt/Al₂O₃ according to embodiments. FIG. 10(a) provides Arrhenius plots of Pt@Al₂O₃ and Pt/Al₂O₃. Reaction mixture: 0.15 vol. % C3H6, 3 vol. % O₂, and 5 vol. % steam (balance Ar). Conversion less than 5%; FIG. 10(b) provides 27Al MAS NMR spectra of fresh and aged Pt@Al₂O₃ and Pt/Al₂O₃. Peaks for four-, five-, and six-coordinated Al (AlO₄, AlO₅, AlO₆) are labeled, with approximate percentages of each shown below the spectra.

FIG. 11 is an example TEM image showing large Pt NPs in a Pt@Al₂O₃ sample according to embodiments after 50 h aging. Aging conditions: 0.15 vol. % C3H6, 10 vol. % O₂, and 5 vol. % H₂O.

FIG. 12 is an example EDS spectrum of as-synthesized PdPt@Al₂O₃ according to embodiments. This shows Pd-Kedge and Pt-Ledge on Ni grid. Fe, Co, Cu, Zr and Sn normal signal from the TEM column/holder.

FIGS. 13(a) to 13(c) illustrate further example aspects of PdPt/Al₂O₃ according to embodiments. FIG. 13(a) illustrates Propene combustion activity for fresh PdPt/Al₂O₃ and aged PdPt/Al₂O₃-1100. PdPt@Al₂O₃-1100 is an 1100° C. aged sample. Reaction conditions: 0.15 vol. % C31H6, 3 vol. % O₂, and 5 vol. % H₂O. Aging performed in air with 10 vol. % steam; FIGS. 13(b) and 13(c) are representative TEM images of fresh (b) and aged (c) PdPt/Al₂O₃, respectively.

FIGS. 14(a) to 14(g) illustrate further example aspects of PdPt/Al₂O₃ according to embodiments. FIG. 14(a) illustrates propene combustion activity of the fresh and 1,100° C. aged metal-free alumina support. Aging conditions: air, 10 vol. % steam; FIGS. 14(b) and 14(c) illustrate characterization of the as-synthesized and 1,100° C. aged PdPt@Al₂O₃: b) XPS; c) XRF; FIGS. 14(d) to 14(g) illustrate example characterization of 1,100° C. aged PdPt@Al₂O₃: FIG. 14(d) is a Representative HAADF-STEM image; FIG. 14(e) is an example EDS spectrum showing no Pd or Pt detectable signal. Fe, Co, Cu, Zr and Sn normal signal from the TEM column/holder; FIG. 14(f) is an example XRD; FIG. 14(g) is an example 27A1 NMR plot.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A process to make a stable and active platinum-alumina catalyst that maintains high activity under harsh conditions, suitable for combusting hydrocarbons, comprising:
encapsulating metal nanoparticles inside a polymer organic framework, and
using a nanocasting technique to convert the polymer into alumina.

2. The process of claim 1, wherein nanocasting includes infiltrating a starting material containing nanoparticles with a metal oxide precursor, and removing the starting material (mold) via thermal treatment leaving behind nanoparticles embedded within the metal oxide matrix.

3. The process of claim 1, further comprising:
depositing colloidally-synthesized metal nanoparticles onto a separately prepared porous polymer (polymer organic framework, POF) through wet impregnation.

4. The process of claim 3, wherein the metal nanoparticles comprise Pt with a size of 3-5 nm.

5. The process of claim 3, wherein encapsulating includes introducing a Pt/POF sample into a polymer growth solution to obtain Pt@POF.

6. The process of claim 3, wherein the metal nanoparticles comprise Pd/Pt.

7. The process of claim 1, wherein encapsulating includes infiltrating the pores of the polymer with an alumina precursor and subsequently removing the polymer by calcination.

8. The process of claim 6, wherein the calcination is performed at around 600° C.

9. A stable and active platinum-alumina catalyst that maintains high activity under harsh conditions, suitable for combusting hydrocarbons, comprising:
metal nanoparticles encapsulated inside a polymer organic framework,
wherein a nanocasting technique is performed to convert the polymer into alumina.

10. The catalyst of claim 9, wherein nanocasting includes infiltrating a starting material containing nanoparticles with a metal oxide precursor, and removing the starting material (mold) via thermal treatment leaving behind nanoparticles embedded within the metal oxide matrix.

11. The catalyst of claim 9, wherein the metal nanoparticles comprise Pt with a size of 3-5 nm.

12. The catalyst of claim 11, wherein encapsulating includes introducing a Pt/POF sample into a polymer growth solution to obtain Pt@POF.

13. The catalyst of claim 9, wherein the metal nanoparticles comprise Pd/Pt.

14. A process to make a stable and active platinum-alumina catalyst that maintains high activity under harsh conditions, suitable for combusting hydrocarbons, comprising:
dissolving alumina in ethanol to obtain a solution;
adding Pt@POF to the solution;
removing ethanol by evaporation and drying to obtain a material; and
calcining the material to obtain mesoporous Al₂O₃.

15. The process of claim 14, wherein the Pt@POF is synthesized by:
preparing POF;
adding melamine and terephthalaldehyde to dimethyl sulfoxide to obtain a content;
processing the content to obtain a solid product of POF;
adding Pt nanoparticles in hexanes to the POF dispersed in a mixture;
drying to obtain a powder if Pt/POF material; and
further processing the Pt/POF material to obtain Pt@POF material.
